(19) United States
(12) Patent Application Publication
(10) Pub. No.: US 2026/0268151 A1
(43) Pub. Date: Sep. 10, 2026

(54) TECHNIQUES FOR USING ARTIFICIAL INTELLIGENCE TO ENRICH DOCUMENTS WITH SELECTIVE PROCESSING OF PRIVATE AND NON-PRIVATE CONTENT INCLUDED IN THE DOCUMENTS

(71) Applicant: Mark Lambert, Tarpon Springs, FL (US)

(72) Inventor: Mark Lambert, Tarpon Springs, FL (US)

(21) Appl. No.: 19/069,556

(22) Filed: Mar. 4, 2025

(51) Int. Cl. G06N 3/09; G06N 3/0455

(52) U.S. Cl. CPC G06N 3/09; G06N 3/0455

(57) ABSTRACT

The present technology uses artificial intelligence (AI) to enrich documents by selectively processing private and non-private content. The process begins by obtaining a document from a profile containing both text and images. A model identifies private and non-private information within the document. Private information of the document, such as names in medical records, is marked for confidentiality, while non-private information remains accessible. A second model generates contextual information to mask the private information, ensuring privacy. This contextual information, along with non-private information of the document, is used by an AI to create enrichment content, such as definitions, annotations, and visual aids. The enrichment content is integrated into the document, enhancing its usability and comprehensibility without compromising privacy. This method can be applied to various document types, including text and images, and supports user customization for specific enrichment needs.

### BACKGROUND

Artificial intelligence (AI) is intelligence exhibited by machines, particularly computer systems. It is a field of research in computer science that develops and studies methods and software that enable machines to perceive their environment and use learning and intelligence to take actions that maximize their chances of achieving defined goals. Such machines may be called AIs. The traditional goals of AI research include reasoning, knowledge representation, planning, learning, natural language processing, perception, and support for robotics. General intelligence—the ability to complete any task performed by a human on an at least equal level—is among the field's long-term goals. In a manner analogous to electricity or computers, AI serves as a general-purpose technology. AI programs emulate perception and understanding and are designed to adapt to new information and new situations.

AIs are quickly becoming an integral part of modern life, changing how humans complete tasks and interact within a digital space in both personal and professional contexts. As AIs have become more ubiquitous, the need for more sophisticated tools to manage and optimize AI interactions has grown.

### BRIEF DESCRIPTION OF THE DRAWINGS

Detailed descriptions of implementations of the present invention will be described and explained through the use of the accompanying drawings.

FIG. 1 is a block diagram illustrating a technique for using artificial intelligence to enrich the text of a document with selective processing of private and non-private content included in the document.

FIG. 2 is a block diagram illustrating a technique for using artificial intelligence to enrich an image of a document with selective processing of private and non-private content included in the document.

FIG. 3 is a block diagram illustrating a portion of a document enriched by artificial intelligence to improve its readability and comprehensibility.

FIG. 4 is a flow diagram that illustrates a process for enriching documents with selective processing of private and non-private content included in the document.

FIG. 5 is a block diagram of an example transformer.

FIG. 6 is a block diagram that illustrates an example of a computer system 500 in which at least some operations described herein can be implemented.

FIG. 7 illustrates a user engaged with a mixed reality system for immersive interaction with enriched documents.

FIG. 8 is a block diagram illustrating a cloud stack and a client stack architecture for a platform that can collectively administer a mixed reality session on a head-mounted display (HMD) device.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Many documents can be cryptic or even incomprehensible based on the nature of their content. The disclosed technology is directed to a system for using artificial intelligence to enrich a document with selective processing of private and non-private content included in the document. The disclosed technology is configured to obtain a document comprising one or more of text and images that include information related to one or more people. The technology uses a first model to identify both private and non-private information of the document. Private information is information unavailable to the public that the individual intends to be confidential (e.g., financial and medical records). Through the use of a second model, the technology generates contextual information based in part on any private information found in the document. The contextual information is information characteristic to the private information that masks the private information (e.g., a relevant tax bracket is extracted from an individual's financial record). Both models are constrained such that the information input into each model is not exposed to the public.

In the disclosed technology, the non-private information of the document and the contextual information extracted from the private information of the document are submitted to a first AI. The first AI generates enrichment content for the document based on the contextual information and the non-private information. The enrichment content can include information, context, or metadata that improves the value, usability, or comprehensibility of the document (e.g., a definition of a complex term within a document). Once the first AI generates the enrichment content, the disclosed technology augments the original document based on the enrichment content (e.g., inserting a definition of a complex term into the document) to result in a final enriched document.

Enhancing documents with artificial intelligence, as described above, can significantly improve their readability and comprehensibility. However, AI processing can potentially expose private information contained in documents like those to be enhanced with the disclosed technology. To address this issue, the disclosed technology removes private information from the document through the use of the two models described above before it undergoes AI processing. This step ensures that sensitive details are protected, thereby easing privacy concerns while still enabling the enrichment of the document with valuable, non-private content.

A pertinent example of the disclosed technology involves medical records. Medical records (e.g., medical history, laboratory results, treatment plans, appointment notes, pharmacy prescriptions, etc.) often include complicated words, abbreviations, pronunciations, charts, scans, images, and more. A layperson reading such a medical record can easily get lost and fail to understand the information the record intends to communicate. Thus, an enhancement of the medical record that improves its comprehensibility can provide significant value to the layperson.

Medical records often include private information of individuals that must be kept confidential. This private information, however, may include context necessary for delivering valuable enhancement. For example, context of a patient having a disease may be necessary to retain from a statement that “Patient X has a cancer” when enhancing the comprehensibility of a diagnosis. The fact that Patient X has cancer, though, is likely private information that should not be exposed through the use of AI processing to enhance the record. As described above, the disclosed technology addresses this issue by first passing the document through secure models that identify the private information and then extracting the necessary context to mask the private information before employing a broader AI to generate enrichment content.

The medical record example above is simply a single example out of many others to which the disclosed technology may apply. As such, the foregoing discussion should not be read as limiting with respect to the type of documents relevant to the disclosed technology.

### Techniques for Using Artificial Intelligence to Enrich Documents with Selective Processing of Private and Non-Private Content Included in the Documents

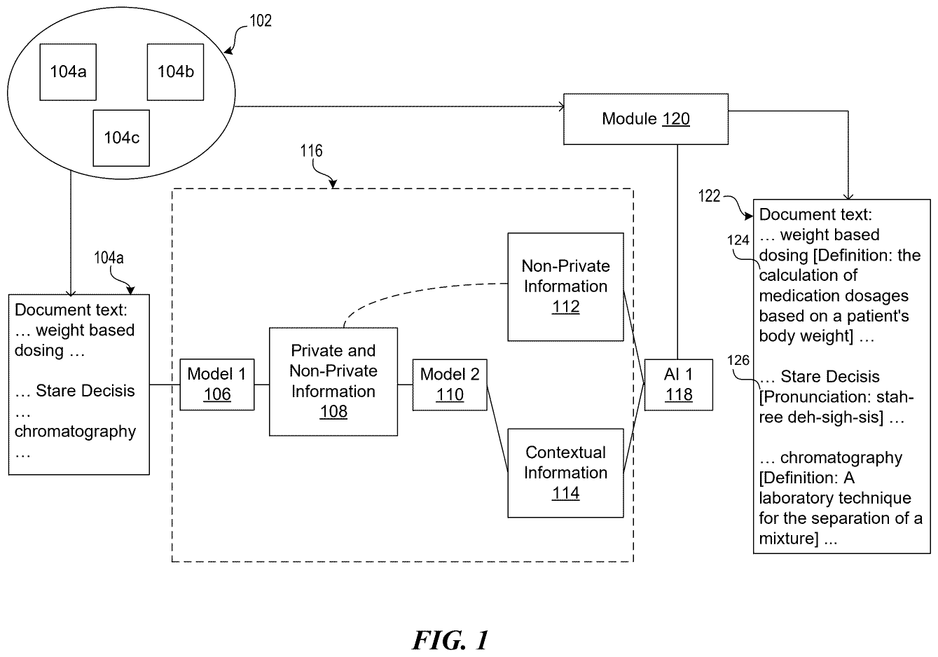

FIG. 1 is a block diagram illustrating a technique for using artificial intelligence to enrich the text of a document with selective processing of private and non-private content included in the document. In FIG. 1, the technology obtains document 104a from a profile 102. As shown, profile 102 includes documents and data 104a, 104b, and 104c related to one or more individuals. Document 104a, obtained from profile 102, can be a .docx file, a PDF file, a .png file, or another computerized file that contains a representation of text. In some embodiments, document 104a can include both text and images. As shown, document 104a includes text with the potentially complicated or confusing terms “weight based dosing,” “Stare Decisis,” and “chromatography.”

Once the disclosed technology obtains document 104a, document 104a is input to model 1 106. Model 1 106 can be a heuristic, a lookup table, a machine learning (ML) model, or another AI capable of natural language processing (NLP). Model 1 106 simply identifies the private and non-private information 108 of document 104a. For example, model 1 106 can be a lookup table that refers to profile 102 to acknowledge the occurrence in document 104a of any name of the one or more individuals associated with profile 102 and thereby mark those occurrences as private information.

Private information is information in a document that is unavailable to the public that the individual intends to be confidential. For example, many individuals wish to keep their association with medical records or financial records confidential and away from public view. As such, their names within those records may be private information. Non-private information, on the other hand, is any information available to the public. In some embodiments, model 1 106 only identifies personally identifiable information and non-personally identifiable information in document 104a. Personally identifiable information directly identifies an individual or, when combined with other data, identifies an individual. For example, an individual's name or social security number is personally identifiable information. Non-personally identifiable information, on the other hand, is information that does not directly identify an individual or, when combined with other data, does not identify an individual. For example, a statement of an injury (e.g., the right foot shows signs of plantar fasciitis) or a discussion of a chemical experiment (e.g., the next step requires use of chromatography) does not directly, or with other data, identify an individual and is therefore non-personally identifiable information.

In some embodiments, model 1 106 is an AI trained to identify private and non-private information 108 of document 104a with a training data set that includes documents with both private and non-private information pre-identified. Such a training process can be specific for a certain document type (e.g., medical records or financial records) or general for all document types. In embodiments where model 1 106 is trained for a specific document type, only documents corresponding to the specific document type are used to train model 1 106. In embodiments where model 1 106 is trained for all document types, a range of document types are used to train model 1 106.

The private and non-private information 108 identified by model 1 106 is input to model 2 110 to extract contextual information 114 that masks the private information. Model 2 110 can be a heuristic, a lookup table, a machine learning (ML) model, or another AI capable of natural language processing (NLP). Contextual information 114 is information generated based, at least in part, on characteristics of individual(s) predicted from the private information. In some embodiments, the contextual information 114 can be generated based on characteristics of individual(s) predicted from one or more of the private information, the non-private information, or the profile 102.

The contextual information 114 is generated to mask the private information included in document 104a such that the contextual information 114 does not include information unavailable to the public that the individual intends to be confidential. Thus, the contextual information 114 may be input to an AI system with less concern for the potential exposure of private information contained in documents to be enhanced. For example, if an individual's name is considered private information but the context is that they are the patient of a medical record, model 2 110 can simply generate contextual information 114 that replaces the patient name with “patient.”

In some embodiments, model 2 110 is an AI trained to extract contextual information 114 from private and non-private information 108 of document 104a with a training data set that includes documents with known relevant contextual information to extract from private and non-private information. Such a training process, like with respect to model 1 106, can be specific for a certain document type (e.g., medical records or financial records) or general for all document types. In embodiments where model 2 110 is trained for a specific document type, only documents corresponding to the specific document type are used to train model 2 110. In embodiments where model 2 110 is trained for all document types, a range of document types are used to train model 2 110.

In some embodiments, the aspects described with respect model 1 106 and model 2 110 are completed by a single model 116. Model 1 106, model 2 110, and single model 116 are each constrained to access only the information described above. As such, each model is constructed to maintain the confidentiality of the private information. In some embodiments, however, a user may request that the technology forgo masking of private information. In such embodiments, the technology may input document 104a directly into AI 1 118 to carry out its operations as described below.

The contextual information 114 generated by model 2 110, along with the non-private information 112 identified by model 1 106, is input into AI 1 118. AI 1 118 can be an ML model, an NLP model, or another AI capable of generating enrichment content relevant to document 104a. With the contextual information 114 and the non-private information 112, AI 1 118 generates enrichment content for document 104a. The enrichment content generated by AI 1 118 can include information, media, or metadata that enhances usability or comprehensibility of document 104a to a user. Examples of enrichment content include highlighting complex terms, definitions and pronunciations of complex terms, visual aids like pictures, tables, and flowcharts, annotations, citations to sources, text re-written in layman's terms, biographies of individuals relevant to document 104a, etc.

In some embodiments, AI 1 118 is trained to generate enrichment content from contextual information 114 and non-private information 112 of document 104a with a training data set that includes documents with known contextual information and non-private information. Such a training process can be specific for a certain document type (e.g., medical records or financial records) or general for all document types. In embodiments where AI 1 118 is trained for a specific document type, only documents corresponding to the specific document type are used to train AI 1 118. In embodiments where AI 1 118 is trained for all document types, a range of document types are used to train AI 1 118. In embodiments where users forgo masking of private information, AI 1 118 is additionally trained to generate enrichment content from documents without contextual information and non-private information identified.

Once AI 1 118 generates the enrichment content, the enrichment content is passed to module 120. Module 120 can be a software engine or other function configured to augment the document 104a. Module 120 is configured to augment document 104a with the enrichment content generated by AI 1 118 and, in some embodiments, with documents or data of profile 102. The augmentation by module 120 of document 104a results in enriched document 122.

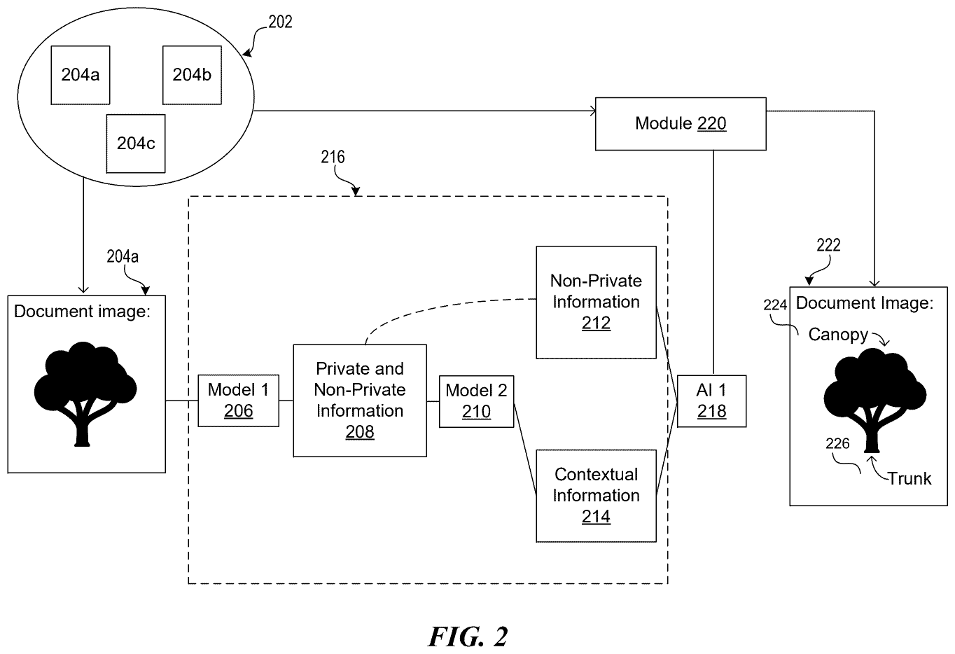

Enriched document 122 can include all or a portion of the enrichment content generated by AI 1 118. Augmentations to document 104a by module 120 to create enriched document 122 can include insertions of content (e.g., definition 124, pronunciation 126, an image, a highlight), insertions of re-written text of document 104a (e.g., all or a portion of the text of document 104a re-written in layman's terms incorporating the definitions in the text with or without the words being defined adjacent thereto and visual aids), embeddings of content accessible by interactions with enriched document 122 (e.g., highlighting a word that, when clicked or hovered by a user cursor, reveals enriched content like definition 124 or a document image 222 as described with respect to FIG. 2), etc. Further, in some embodiments, module 120 can add to or enhance the enrichment content generated by AI 1 118 with additional documents and data from profile 102. As such, enriched document 122 can include enrichment more tailored to the individual without exposing more potentially private information to AI processing.

In some embodiments of the disclosed technology, a user can select one or more types of enrichment content for AI 1 118 to generate. For example, a user can request that AI 1 118 only generate definitions of complex words found in document 104a. Similarly, in some embodiments, a user can select one or more types of augmentations to apply to create enriched document 122. For example, a user can request that only pronunciations of complex words be inserted into the document or that only embeddings of content accessible by interactions with the enriched document 122 be applied.

FIG. 2 is a block diagram illustrating a technique for using artificial intelligence to enrich an image of a document with selective processing of private and non-private content included in the document. The technique of FIG. 2 can be generally similar to the technique of FIG. 1 described above. Thus, similar reference numbers are used across FIGS. 1 and 2 to denote identical or at least generally similar components, and a detailed description of several similar aspects of the technique of FIG. 2 is largely omitted here for the sake of brevity in light of the detailed description of the technique of FIG. 1 provided above.

Similar to the technique for enriching text of a document described above with respect to FIG. 1, the technique for enriching an image of a document of FIG. 2 includes a profile 202 with documents and data 204a, 204b, and 204c related to one or more individuals. Document 204a, a .docx file, a PDF file, a .png file, or another computerized file that contains a representation of text is obtained from profile 202. In some embodiments, document 204a can include both text and images. As shown, document 204a includes an unlabeled image of a tree.

The descriptions provided above with respect to model 1 106, private and non-private information 108, model 2 110, non-private information 112, contextual information 114, and single model 116 of FIG. 1 apply equally to model 1 206, private and non-private information 208, model 2 210, non-private information 212, contextual information 214, and single model 216.

Unlike model 1 106, an example of identification of private information of model 2 206 can be a heuristic that refers to profile 202 to match a picture of one or more individuals in document 204a to profile pictures of the one or more individuals of profile 202 to identify an image of document 204a as private information. Further, unlike model 2 110, an example of contextual information generated by model 2 210 that masks private information can be shrouding a face of an individual in a medical report to only show a portion of their skin with a blemish at issue in the medical report.

Contextual information 214 generated by model 2 210, along with the non-private information 212 identified by model 1 206, is input into AI 1 218. AI 1 218 can be an ML model or another AI capable of generating enrichment content relevant to document 204a. With the contextual information 214 and the non-private information 212, AI 1 218 generates enrichment content for document 204a. The enrichment content generated by AI 1 218 can include information, media, or metadata that enhances usability or comprehensibility of document 204a to a user. Examples of enrichment content include labels of image elements, definitions and pronunciation of complex terms related to the image or included therein, additional visual aids like pictures, tables, and flowcharts, image annotations, citations to sources, biographies of individuals relevant to subjects in the image of document 204a, etc.

Similar to the technique of FIG. 1, once AI 1 218 generates the enrichment content, the enrichment content is passed to module 220. Module 220 can be a software engine or other function configured to augment the document 204a. Module 220 is configured to augment document 204a with the enrichment content generated by AI 1 218 and, in some embodiments, with documents or data of profile 202. The augmentation by module 220 of document 204a results in enriched document 222.

Enriched document 222 can include all or a portion of the enrichment content generated by AI 1 218. Augmentations to document 204a by module 220 to create enriched document 222 can include insertions of content (e.g., labels 224 and 226 or text describing the meaning of the subject of the image), adjustments to the image of document 204a, embeddings of content accessible by interactions with enriched document 222 (e.g., highlighting a label that reveals further description of the label when clicked or when hovered over by a user cursor), etc. Further, in some embodiments, module 220 can add to or enhance the enrichment content generated by AI 1 218 with additional documents and data from profile 202. As such, enriched document 222 can include enrichment more tailored to the individual without exposing more potentially private information to AI processing.

In some embodiments of the disclosed technology, a user can select one or more types of enrichment content for AI 1 218 to generate. For example, a user can request that AI 1 218 only generate labels of elements of the document image relevant to the meaning of the document. Similarly, in some embodiments, a user can select one or more types of augmentations to apply to create enriched document 222. For example, a user can request that only embeddings of content accessible by interactions with the enriched document 222 be applied.

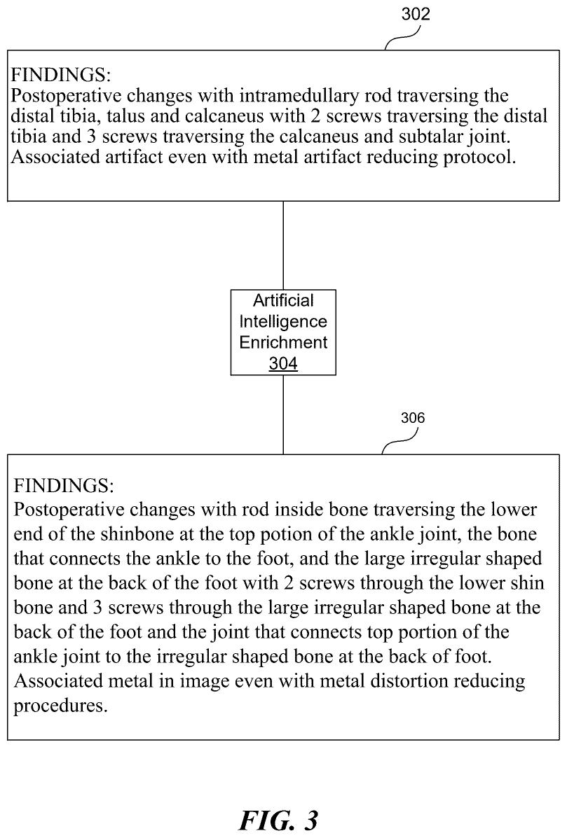

FIG. 3 is a block diagram illustrating a portion of a document enriched by artificial intelligence to improve its readability and comprehensibility. Document 302 includes “Findings” of a medical examination described with complicated medical jargon. Artificial intelligence enrichment 304 is a simplified marker referring to the technique for using artificial intelligence to enrich the text of a document as described with respect to FIG. 1. Document 306 is the enriched version of document 302 after processing by artificial intelligence enrichment 304.

As shown, the “Findings” of document 302 are re-written in layman's terms to improve the readability and comprehensibility of the document for an average, non-medically trained reader. For example, the term “intramedullary” of document 302 is removed from the phrase “intramedullary rod” and the words “inside bone” are inserted such that a lay reader can understand that an intramedullary rod is a rod placed inside a bone.

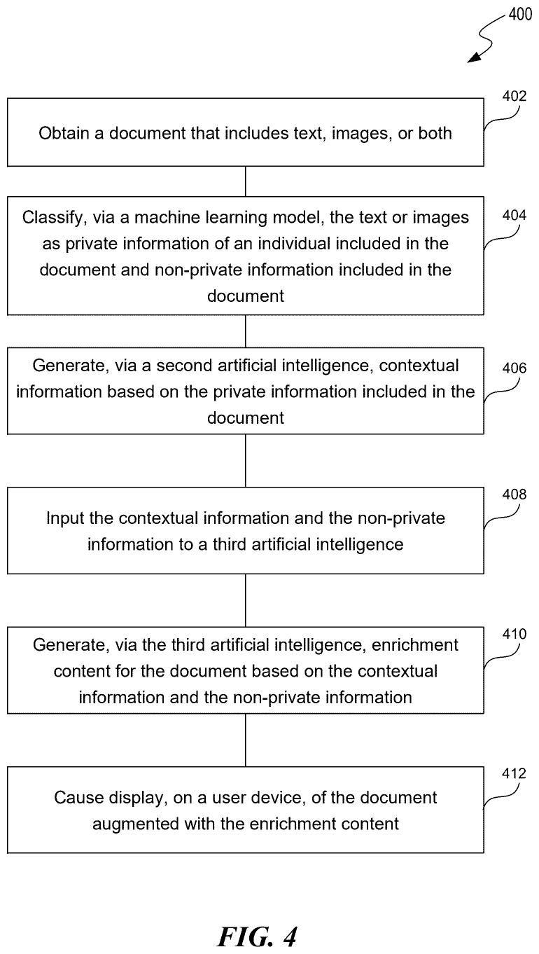

FIG. 4 is a flow diagram that illustrates a system 400 for enriching documents with selective processing of private and non-private content included in the document. At 402, the system obtains a document that includes text, images, or both with information related to one or more individuals.

At 404, the system uses a first model to classify the text or images as private information of an individual included in the document and non-private information included in the document. Private information is information unavailable to the public that the individual intends to be confidential, whereas non-private information is information available to the public. In some embodiments, the first model classifies the text or images as personally identifiable information of an individual included in the document and non-personally identifiable information included in the document. In such an embodiment, personally identifiable information directly identifies the individual or, when combined with other data, identifies the individual. Non-personal information in these embodiments is information that does not directly identify the individual or, when combined with other data, identify the individual. In one embodiment, the first model is trained to identify the private information of the document and the non-private information of the document based on a plurality of electronic medical records including private information and non-private information pre-identified.

At 406, the system uses a second model to generate contextual information based on the private information included in the document. The contextual information is generated by the second model based on characteristics of the individual predicted from the private information. Further, the contextual information is configured to mask the private information (e.g., replacing a name with a non-identifiable reference “patient”).

In some embodiments, the first and second models of steps 404 and 406 can be a simple heuristic or a lookup table, as well as a more complicated machine learning (ML) model or another AI capable of natural language processing (NLP). In some embodiments, the first and second models of steps 404 and 406 are a single model configured to undertake steps 404 and 406. In yet further embodiments, users can forgo masking their private information and the technology may input the document directly into a first artificial intelligence described below with respect to step 408.

At 408, the system inputs the contextual information from step 406 and the non-personally identifiable information from step 404 to a first artificial intelligence. Then, at 410, the first artificial intelligence generates enrichment content for the document based on the contextual information and the non-personally identifiable information. Such enrichment content includes information, media, or metadata that enhances usability or comprehensibility of the document to a user. In embodiments where users forgo masking of private information, the first artificial intelligence generates enrichment content from the document without the contextual information from step 406 and the non-personally identifiable information from step 404.

At 412, the system causes a user device to display the document augmented with the enrichment content generated at step 408. The system can augment the document with the enrichment content in a variety of ways, including by editing the document to include definitions of terms of the document, editing the document to include pronunciations of terms of the document, editing the document to add labels to an image of the document, editing the document to re-write text in layman's terms, or adding additional images, tables, or charts to the document, editing the document to include a plurality of sources for the enrichment content, etc. In the case of editing the document to include a plurality of sources for the enrichment content, the sources can include an in-text citation, a footnote, a bibliography, and a link to locations in the obtained document, external articles, webpages, videos, or other sources of information accessible by the first artificial intelligence.

In some embodiments, the system will identify one or more additional documents or data associated with a profile related to the one or more individuals. Information from such additional documents or data can include enrichment content relevant to the document. In these embodiments, the system can cause the user device to display the document augmented with the additional enrichment content. In yet further embodiments, the system can receive, from a user, a request for a particular enrichment content. The particular enrichment content can be particular information, context, or metadata relevant to the document (e.g., particular definitions of complex terms within the document). Upon request, the first artificial intelligence can generate this particular enrichment content for the document based on the contextual information, the non-personally identifiable information, and the request for the particular enrichment content. Then, once the particular enrichment content is generated by the first artificial intelligence, the system can augment the document with the particular enrichment content.

In some embodiments, the document augmented with the enrichment content can be rendered via a virtual reality, augmented reality, or mixed reality device. In such embodiments, the system can receive an indication of a detected input including through a physical gesture or motion of a wand device. Then, in response to the indication of the detected input, the system can navigate the document augmented with the enrichment content with the virtual reality, augmented reality, or mixed reality device.

### Transformer for Neural Network

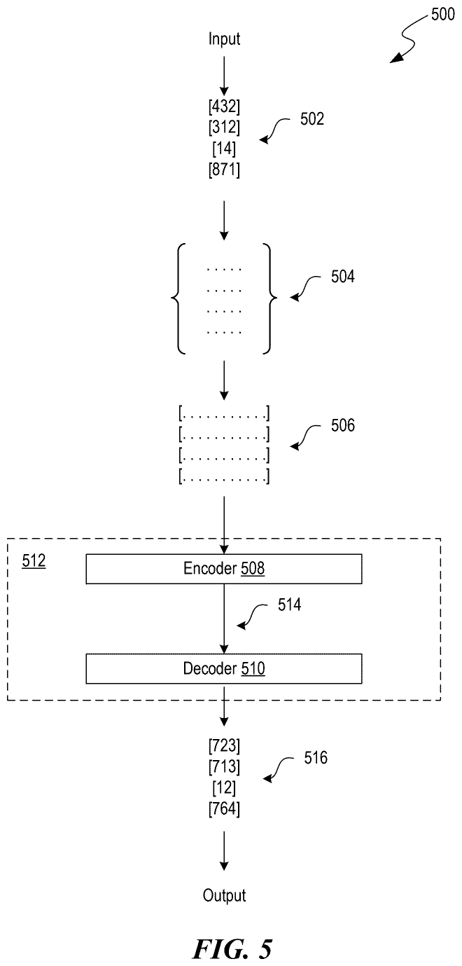

To assist in understanding the present disclosure, some concepts relevant to AI 500 in FIG. 5 including neural networks and machine learning (ML) are discussed herein. As described in this application, AI 500 can be used to enrich documents with selective processing of private and non-private content included in the documents.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), generative adversarial networks (GANs), variational autoencoders (VAEs), and autoregressive models, among others.

DNNs are often used as ML-based models for modeling complex behaviors (e.g., human language, image recognition, object classification, etc.) in order to improve the accuracy of outputs (e.g., more accurate predictions), for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online web pages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimizing a loss or maximizing a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performance-trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses large language models (LLMs).

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistants).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 5 is a block diagram of an example transformer 512. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as RNN-based language models.

The transformer 512 includes an encoder 508 (which can include one or more encoder layers/blocks connected in series) and a decoder 510 (which can include one or more decoder layers/blocks connected in series). Generally, the encoder 508 and the decoder 510 each include multiple neural network layers, at least one of which can be a self-attention layer. The parameters of the neural network layers can be referred to as the parameters of the language model.

The transformer 512 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 512 is trained to perform certain functions on other input formats than natural language input. For example, the input can include objects, images, audio content, or video content, or a combination thereof.

The transformer 512 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 5 illustrates an example of how the transformer 512 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, and other tokens can provide formatting information, etc.

In FIG. 5, a short sequence of tokens 502 corresponding to the input text is illustrated as input to the transformer 512. Tokenization of the text sequence into the tokens 502 can be performed by some pre-processing tokenization module such as, for example, a byte-pair encoding tokenizer (the “pre” referring to the tokenization occurring prior to the processing of the tokenized input by the LLM), which is not shown in FIG. 5 for brevity. In general, the token sequence that is inputted to the transformer 512 can be of any length up to a maximum length defined based on the dimensions of the transformer 512. Each token 502 in the token sequence is converted into an embedding vector 506 (also referred to as “embedding 506”).

An embedding 506 is a learned numerical representation (such as, for example, a vector) of a token that captures some semantic meaning of the text segment represented by the token 502. The embedding 506 represents the text segment corresponding to the token 502 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 506 corresponding to the “write” token will be closer to another embedding corresponding to the “jot down” token in the vector space as compared to the distance between the embedding 506 corresponding to the “write” token and another embedding corresponding to the “summary” token.

The vector space can be defined by the dimensions and values of the embedding vectors. Various techniques can be used to convert a token 502 to an embedding 506. For example, another trained ML model can be used to convert the token 502 into an embedding 506. In particular, another trained ML model can be used to convert the token 502 into an embedding 506 in a way that encodes additional information into the embedding 506 (e.g., a trained ML model can encode positional information about the position of the token 502 in the text sequence into the embedding 506). In some implementations, the numerical value of the token 502 can be used to look up the corresponding embedding in an embedding matrix 504, which can be learned during training of the transformer 512.

The generated embeddings 506 are input into the encoder 508. The encoder 508 serves to encode the embeddings 506 into feature vectors 514 that represent the latent features of the embeddings 506. The encoder 508 can encode positional information (i.e., information about the sequence of the input) in the feature vectors 514. The feature vectors 514 can have very high dimensionality (e.g., on the order of thousands or tens of thousands), with each element in a feature vector 514 corresponding to a respective feature. The numerical weight of each element in a feature vector 514 represents the importance of the corresponding feature. The space of all possible feature vectors 514 that can be generated by the encoder 508 can be referred to as a latent space or feature space.

Conceptually, the decoder 510 is designed to map the features represented by the feature vectors 514 into meaningful output, which can depend on the task that was assigned to the transformer 512. For example, if the transformer 512 is used for a translation task, the decoder 510 can map the feature vectors 514 into text output in a target language different from the language of the original tokens 502. Generally, in a generative language model, the decoder 510 serves to decode the feature vectors 514 into a sequence of tokens. The decoder 510 can generate output tokens 516 one by one. Each output token 516 can be fed back as input to the decoder 510 in order to generate the next output token 516. By feeding back the generated output and applying self-attention, the decoder 510 can generate a sequence of output tokens 516 that has sequential meaning (e.g., the resulting output text sequence is understandable as a sentence and obeys grammatical rules). The decoder 510 can generate output tokens 516 until a special [EOT] token (indicating the end of the text) is generated. The resulting sequence of output tokens 516 can then be converted to a text sequence in post-processing. For example, each output token 516 can be an integer number that corresponds to a vocabulary index. By looking up the text segment using the vocabulary index, the text segment corresponding to each output token 516 can be retrieved, the text segments can be concatenated together, and the final output text sequence can be obtained.

In some implementations, the input provided to the transformer 512 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use autoregression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Computer System

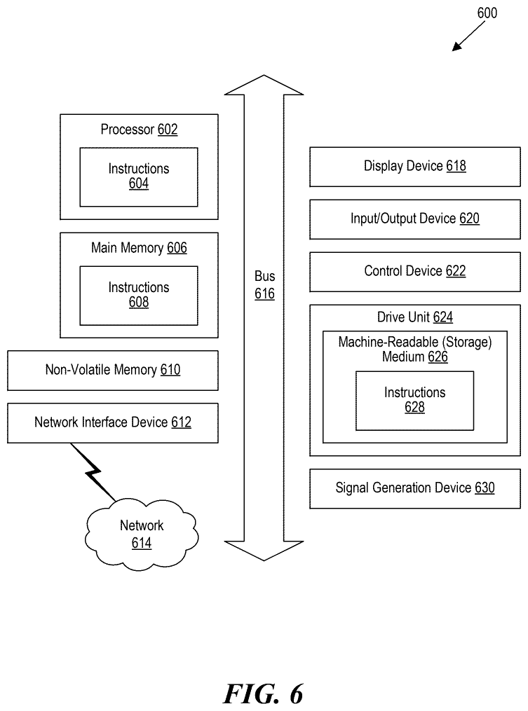

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the Figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

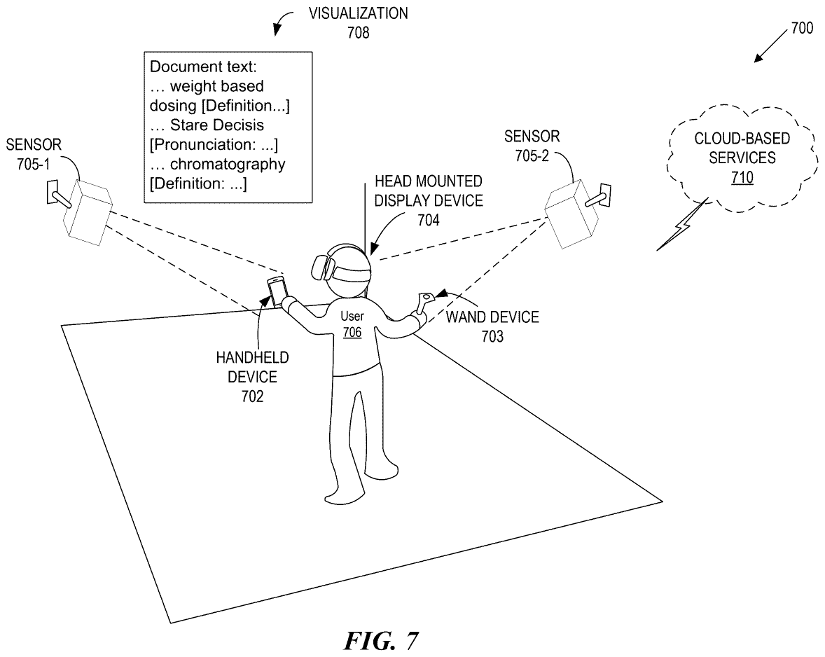

FIG. 7 illustrates a user engaged with a mixed reality system 700 for immersive interaction with enriched documents. The components of the system 700 can include a handheld device 702 that administers a session running on other components of the system 700 including a head-mounted display (HMD) device 704 that renders a partial or full 360-degree interface. The system 700 can also include motion or position sensors 705-1 and 705-2, which are fixed in a room or worn by the user 706 such as, for example, sensors of wearables. The HMD device 704 can be an AR/VR/XR device. In some embodiments the HMD device 704 can include glasses.

A near-eye display device, commonly referred to as an HMD device, is an optical apparatus designed to present visual information directly in front of the user's eyes. This technology is composed of several integral components that work in unison to deliver a seamless and immersive visual experience.

Central to the near-eye display device lies the optical module. The optical module includes lenses and other optical elements that project images from a microdisplay or similar image source directly into the user's eyes. The optical module is engineered to ensure that the images are clear, focused, and appear at a comfortable viewing distance, thereby enhancing the overall user experience.

The microdisplay is a small yet high-resolution display panel responsible for generating the visual content. Utilizing technologies such as Liquid Crystal Display (LCD), Organic Light Emitting Diode (OLED), Liquid Crystal on Silicon (LCoS), or Digital Light Processing (DLP), the microdisplay renders the images or video content that the user perceives.

Supporting these components is the frame and housing, which provides the structural integrity needed to hold the optical module and microdisplay in place. Designed to be lightweight and comfortable for extended wear, the frame often includes adjustable straps or other mechanisms to ensure a secure and personalized fit on the user's head.

Modern near-eye display devices are equipped with an array of sensors, including accelerometers, gyroscopes, magnetometers, and eye-tracking sensors. These sensors enable head tracking, motion detection, and gaze tracking, significantly enhancing the interactivity and immersive nature of the device. The data collected by these sensors is processed by a built-in or connected processing unit, which handles the computation required for rendering images, processing sensor data, and managing user inputs. This processing unit may be integrated into the device or connected via a wired or wireless link to an external computer or mobile device.

Connectivity interfaces such as USB, HDMI, Bluetooth, or Wi-Fi are also integral to the device, allowing it to interface with external devices, transfer data, or receive content. The power supply, typically a battery or power management system, provides the necessary energy to operate the device efficiently, supporting extended usage without frequent recharging.

User interaction with the near-eye display device is facilitated through various user interface options, including physical buttons, touchpads, voice control, or gesture recognition systems. Additionally, some devices feature integrated speakers or headphone jacks to provide audio output, further enhancing the multimedia experience.

As illustrated, the handheld device 702 operates as a wand to navigate objects of the visualization 708 experienced by the user 706 through the HMD device 704. A dedicated wand device 703 (e.g., with one or more dedicated hardware buttons) can additionally or alternatively be used for navigation. In another example, the sensors 705-1 and 705-2 can detect the position and/or movement of the user's hands and/or fingers in the air to perform various functions (e.g., a pinching motion of the user's fingers can trigger a zooming function) including the navigating the enriched document of FIGS. 1 through 3, which could be rendered in a mixed reality session, e.g., on the handheld device 702. For example, the embeddings of content accessible by interactions with enriched document can be presented to the user 706 through the visualization 708.

In some embodiments, some components of the system 700 are remotely located from the user. For example, cloud components can provide cloud-based services 710 to administer the mixed reality session running on the components of the system 700 or provide services or content for a mixed reality session. Hence, administration of a mixed reality session could be through the HMD device 704, augmented with the handheld device 702, and/or with the cloud-based services 710 that receives session progress feedback (e.g., anywhere outside of a room where the user is experiencing a simulation).

As shown, the HMD device 704 can provide content (e.g., visualization 708) of a mixed reality session and process feedback from the user via the handheld device 702 to navigate the visualization 708. As shown, the HMD device 704 is a near-to-eye display system that is worn by the user 706. For example, the HMD device 704 can have a chassis and various electrical and optical components to enable an immersive experience by the user 706 wearing the HMD device 704. For example, the HMD device 704 can include a display for each of the user's eyes. The displays can render a real-world scene of a simulation for view by the user's eyes when the HMD device 704 is worn by the user. The HMD device 704 can also include a camera mounted to the chassis. The camera can capture movement of the user's pupils for physiological feedback responsive to simulated scenes being rendered. The HMD device 704 may also include a network interface enabling the handheld device 702 to communicatively couple to the HMD device 704 over a wireless connection.

In some embodiments, the HMD device 704 includes features for measuring the user's physiological activity. For example, the HMD device 704 can include components to measure the user's electrical brain activity. As such, the HMD device 704 can collect physiological data in combination with any direct input by the user. In some embodiments, the physiological data can be used to supplement the user's conscious inputs. In some embodiments, the physiological data could be used to compare against the user's conscious input.

In one example, the HMD device 704 can render a virtual immersive environment by displaying images in view of the user's eyes such that the user can only see the images (e.g., visualization 708) and see nothing of the real-world. The HMD device 704 can also render an AR environment. As such, the user can see the visualization 708 overlaying the real world while the HMD device 704 is worn by the user 706. Hence, to achieve an AR environment, the user in an augmented reality simulation has a transparent view with digital objects overlaid or superimposed on the user's real-world view.

Examples of the sensors 705-1 and 705-2 include cameras or motion detectors that are positioned proximate to the user such that the sensors 705-1 and 705-2 can obtain real-world feedback responsive to interactions with a simulated real-world scene. For example, cameras facing the user can detect the user 706's movement while the user is engaged in a simulation and provide feedback to the HMD device 704 administering the simulation. The handheld device 702 can be used by the user 706 to submit input, which can include actuating buttons for the user 706 to input data and/or accelerometers that detect spatial movement. For example, the user 706 can move the handheld device 702 to provide inputs responsive to a scene administered by the HMD device 704.

The visualization 708 is one example of many that can be rendered in a mixed reality session. As described further below, the system 700 can include servers that are remotely located from the user 706 and can access a program administered by the HMD device 704. Further, a local software generation and distribution framework can be used to rapidly scale content. The core components and services can support complex user and session elements that can be easily managed by a service provider. As such, a platform of a mixed reality system can standardize interaction elements such as a session landing, sign-in, navigation rules, and the like. A top-level abstraction layer can support customization such as a sequence of sessions or scenes or conditional ordering of sessions or scenes. Services can include authentication, tracking, reports, user services, help services, pause and resume services, and the like.

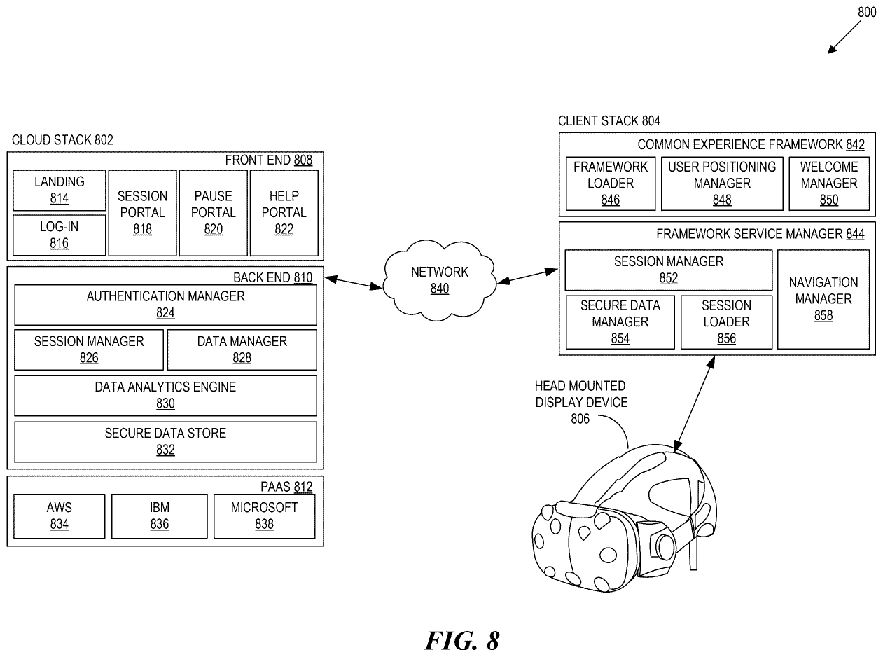

FIG. 8 is a block diagram illustrating a cloud stack 802 and a client stack 804 architecture for a platform 800 that can collectively administer a mixed reality session on an HMD device 806. As shown, the cloud stack 802 includes three primary layers: a front end layer 808, a back end layer 810, and a platform as a service (PaaS) layer 812. The front end layer 808 includes a landing component 814 and a login component 816. The two components 814 and 816 are executed at the beginning of a session administered to orient a user and seek login credentials to control access to enriched documents and user information of the platform 800. The front end layer 808 also includes a session portal 818, pause portal 820, and help portal 822. The session portal 818 is for normal front-facing operations of a simulation session whereas the pause portal 820 is for operations while the session is paused. Lastly, the help portal 822 can help the user or administrator to address questions related to the platform 800 or simulation.

The back end layer 810 includes an authentication manager 824 that can authenticate a user and/or an administrator of the platform 800. A session manager 826 can manage access to a particular session. A data manager 828 can manage user data and/or data about the session such as any feedback from users while engaged in sessions. For example, the data manager 828 can collect feedback data from multiple users including their inputs and physiological data. A data analytics engine 830 can process the collected data to determine the actions of users and to learn how to improve the sessions (e.g., mixed reality scenes). A secure data store 832 can store sensitive data such as data that identifies users. Lastly, the PaaS layer 812 includes cloud computing services that provide the platform 800 for clients to administer the mixed reality sessions. Examples include AMAZON WEB SERVICES (AWS) 834, or services provided by IBM 836 and/or MICROSOFT 838.

The cloud stack 802 is communicatively connected to the client stack 804 over a network 840 such as the internet. The client stack 804 includes a common experience framework layer 842 and a framework service manager layer 844. The common experience framework layer 842 includes a framework loader 846 to load the framework for a session, a user positioning manager 848 to monitor and track the relative position of the user engaged with the session, and a welcome manager 850 to orient the user at the beginning of the session.

The framework service manager layer 844 includes a session manager 852 to manage the session experienced by a user wearing the HMD device 806. The framework service manager layer 844 also includes a secure data manager 854 to store or anonymize any sensitive data, session load manager 856 for loading a session, and a navigation manager 858 for navigating a user through mixed reality scenes of an enriched document. The platform 800 is merely illustrative to aid the reader in understanding an embodiment. Other embodiments may include fewer or additional layers/components known to persons skilled in the art but omitted for brevity.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above and any that may be listed in accompanying filing papers are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded thereon, wherein the instructions, when executed by at least one data processor of a system, cause the system to:
obtain a document that includes text, images, or both,
wherein the document includes information related to one or more individuals;
classify, via a first model, the text or images as personally identifiable information of an individual included in the document and non-personally identifiable information included in the document,
wherein the personally identifiable information directly identifies the individual or, when combined with other data, identifies the individual;
generate, via a second model, contextual information based on the personally identifiable information included in the document,
wherein the contextual information is generated based on characteristics of the individual predicted from the personally identifiable information, and
wherein the contextual information is configured to mask the personally identifiable information;
input the contextual information and the non-personally identifiable information to a first artificial intelligence;
generate, via the first artificial intelligence, enrichment content for the document based on the contextual information and the non-personally identifiable information,
wherein the enrichment content includes information, media, or metadata that enhances usability or comprehensibility of the document to a user; and
cause display, on a user device, of the document augmented with the enrichment content.

2. The non-transitory, computer-readable storage medium of claim 1, comprising instructions configured to cause the system to:
augment the document with the enrichment content, by:
editing the document to include definitions of terms of the document;
editing the document to include pronunciations of terms of the document;
editing the document to add labels to an image of the document;
editing the document to re-write text in layman's terms; or
adding additional images, tables, or charts to the document.

3. The non-transitory, computer-readable storage medium of claim 2, comprising instructions configured to cause the system to:
edit the document to include a plurality of sources for the enrichment content,
wherein the plurality of sources include an in-text citation, a footnote, a bibliography, or a link;
wherein the plurality of sources are locations in the obtained document, external articles, webpages, videos, or other sources of information accessible by the first artificial intelligence.

4. The non-transitory, computer-readable storage medium of claim 1, comprising instructions configured to cause the system to:
identify an additional document of a profile related to the one or more individuals,
wherein information of the additional document includes additional enrichment content for the document; and
cause display, on the user device, of the document augmented with the additional enrichment content.

5. The non-transitory, computer-readable storage medium of claim 1, comprising instructions configured to cause the system to:
receive, from a user, a request for a particular enrichment content,
wherein the particular enrichment content is particular information, context, or metadata;
generate, via the first artificial intelligence, the particular enrichment content for the document based on the contextual information, the non-personally identifiable information, and the request for the particular enrichment content; and
augment the document with the particular enrichment content.

6. The non-transitory, computer-readable storage medium of claim 1, wherein the first model is trained to identify the personally identifiable information of the document and the non-personally identifiable information of the document based on a plurality of electronic medical records including personally identifiable information and non-personally identifiable information pre-identified.

7. The non-transitory, computer-readable storage medium of claim 1, wherein to cause display of the document augmented with the enrichment content comprises causing the system to:
render the document augmented with the enrichment content via a virtual reality, augmented reality, or mixed reality device.

8. The non-transitory, computer-readable storage medium of claim 7, wherein the system is further caused to:
receive an indication of detected input including a physical gesture or motion of a wand device, a user hand, or a user finger; and
in response to the indication of the detected input, cause navigation of the document augmented with the enrichment content with the virtual reality, augmented reality, or mixed reality device.

9. A method comprising:
obtaining a document that includes text, images, or both,
wherein the document includes information related to one or more individuals;
classifying, via a first model, the text or images as private information of an individual included in the document and non-private information included in the document,
wherein the private information is information unavailable to a public that the individual intends to be confidential;
generating, via a second model, contextual information based on the private information included in the document,
wherein the contextual information is generated based on characteristics of the individual predicted from the private information, and
wherein the contextual information is configured to mask the private information;
inputting the contextual information and the non-private information to a third artificial intelligence;
generating, via a first artificial intelligence, enrichment content for the document based on the contextual information and the non-private information,
wherein the enrichment content includes information, media, or metadata that enhances usability or comprehensibility of the document to a user; and
causing display, on a user device, of the document augmented with the enrichment content.

10. The method of claim 9, further comprising:
augmenting the document with the enrichment content, by:
editing the document to include definitions of terms of the document;
editing the document to include pronunciations of terms of the document;
editing the document to add labels to an image of the document;
editing the document to re-write text in layman's terms; or
adding additional images, tables, or charts to the document.

11. The method of claim 10, further comprising:
editing the document to include a plurality of sources for the enrichment content,
wherein the plurality of sources include an in-text citation, a footnote, a bibliography, or a link;
wherein the plurality of sources are locations in the obtained document, external articles, webpages, videos, or other sources of information accessible by the first artificial intelligence.

12. The method of claim 9, further comprising:
identifying an additional document of a profile related to the one or more individuals,
wherein information of the additional document includes additional enrichment content for the document; and
causing display, on the user device, of the document augmented with the additional enrichment content.

13. The method of claim 9, further comprising:
receiving, from a user, a request for a particular enrichment content,
wherein the particular enrichment content is particular information, context, or metadata;
generating, via the first artificial intelligence, the particular enrichment content for the document based on the contextual information, the non-private information, and the request for the particular enrichment content; and
augmenting the document with the particular enrichment content.

14. The method of claim 9, wherein the first model is trained to identify the private information of the document and the non-private information of the document based on a plurality of electronic medical records including private information and non-private information pre-identified.

15. The method of claim 9, wherein causing display of the document augmented with the enrichment content further comprises:
rendering the document augmented with the enrichment content via a virtual reality, augmented reality, or mixed reality device.

16. The method of claim 15, further comprising:
receiving an indication of detected input including a physical gesture or motion of a wand device, a user hand, or a user finger; and
in response to the indication of the detected input, causing navigation of the document augmented with the enrichment content with the virtual reality, augmented reality, or mixed reality device.

17. A system comprising:
at least one hardware processor; and
at least one non-transitory memory storing instructions, which, when executed by the at least one hardware processor, cause the system to:
obtain a document that includes text, images, or both,
wherein the document includes information related to one or more individuals;
classify, via a first artificial intelligence, the text or images as private information of an individual included in the document and non-private information included in the document,
wherein the private information is information unavailable to a public that the individual intends to be confidential;
generate, via a second artificial intelligence, contextual information based on the private information included in the document,
wherein the contextual information is generated based on characteristics of the individual predicted from the private information, and
wherein the contextual information is configured to mask the private information;
input the contextual information and the non-private information to a third artificial intelligence;
generate, via the third artificial intelligence, enrichment content for the document based on the contextual information and the non-private information,
wherein the enrichment content includes information, media, or metadata that enhances usability or comprehensibility of the document to a user; and
cause display, on a user device, of the document augmented with the enrichment content.

18. The system of claim 17, further caused to:
augment the document with the enrichment content, by:
editing the document to include definitions of terms of the document;
editing the document to include pronunciations of terms of the document;
editing the document to add labels to an image of the document;
editing the document to re-write text in layman's terms; or
adding additional images, tables, or charts to the document.

19. The system of claim 18, further caused to:
edit the document to include a plurality of sources for the enrichment content,
wherein the plurality of sources include an in-text citation, a footnote, a bibliography, or a link;
wherein the plurality of sources are locations in the obtained document, external articles, webpages, videos, or other sources of information accessible by the third artificial intelligence.

20. The system of claim 18, further caused to:
identify an additional document of a profile related to the one or more individuals,
wherein information of the additional document includes additional enrichment content for the document; and
cause display, on the user device, of the document augmented with the additional enrichment content.

21. The system of claim 17, further caused to:
receive, from a user, a request for a particular enrichment content,
wherein the particular enrichment content is particular information, context, or metadata;
generate, via the third artificial intelligence, the particular enrichment content for the document based on the contextual information, the non-private information, and the request for the particular enrichment content; and
augment the document with the particular enrichment content.

22. The system of claim 17, wherein to cause display of the document augmented with the enrichment content comprises causing the system to:
render the document augmented with the enrichment content via a virtual reality, augmented reality, or mixed reality device.

23. The system of claim 22, further caused to:
receive an indication of detected input including a physical gesture or motion of a wand device, a user hand, or a user finger; and
in response to the indication of the detected input, cause navigation of the document augmented with the enrichment content with the virtual reality, augmented reality, or mixed reality device.
